(19) United States
(12) Patent Application Publication
(10) Pub. No.: US 2013/0149424 A1
(43) Pub. Date: Jun. 13, 2013

(54) BREWING DEVICE FOR EXTRACTING A PORTION CAPSULE, METHOD FOR OPERATING A BREWING DEVICE AND USE OF A BREWING DEVICE

(71) Applicant: Eugster/Frismag AG Electrohaushaltgerate, Amriswil (CH)

(72) Inventor: Daniel FISCHER, Romanshorn (CH)

(73) Assignee: EUGSTER/FRISMAG AG ELECTROHAUSHALTGERATE, Amriswil (CH)

(21) Appl. No.: 13/687,060

(22) Filed: Nov. 28, 2012

Related U.S. Application Data
(63) Continuation of application No. PCT/EP2011/002526, filed on May 20, 2011.

(30) Foreign Application Priority Data
May 28, 2010 (DE) 10 2010 021 847.2
Feb. 14, 2011 (DE) 10 2011 011 204.9

(51) Int. Cl. A47J 31/40

(52) U.S. Cl. CPC A47J 31/407
USPC 426/431; 99/295

(57) ABSTRACT

The invention relates to a brewing device for extracting portion capsules, comprising first and second brewing chamber elements, wherein the first brewing chamber element can move between a loading position, in which the first and second brewing chamber elements are spaced apart from one another, and an extraction position, in which the first and second brewing chamber elements are brought closer together in order to form a closed brewing chamber, and wherein during movement the first brewing chamber element carries out a linear displacement along an axial direction when the first and second brewing chamber elements are spaced apart from one another, and additionally carries out a pivoting movement about a pivot axis perpendicular to the axial direction when the first and second brewing chamber elements are brought together at least to some extent.

### CROSS REFERENCE TO RELATED APPLICATIONS

This application is a Continuation of International Application No. PCT/EP2011/002526, filed on May 20, 2011, entitled BREWING DEVICE FOR EXTRACTING A PORTION CAPSULE, METHOD FOR OPERATING A BREWING DEVICE AND USE OF A BREWING DEVICE, which application is hereby incorporated by reference in its entirety.

### BACKGROUND

The present invention relates to a brewing device for extracting a portion capsule, comprising a first brewing chamber element and a second brewing chamber element, wherein the first brewing chamber element is movable between a loading position, in which the first and the second brewing chamber elements are spaced apart from each other, and an extraction position, in which the first and the second brewing chamber elements are brought closer together in order to form a substantially closed brewing chamber.

Brewing devices of this type are known in general. For example, EP 2 077 087 A1 discloses a brewing device for a portion capsule, which brewing device comprises a second brewing chamber element in the form of a receiving element with a cavity for receiving the portion capsule and a first brewing chamber element in the form of a closure element for closing the cavity. The closure element here comprises an injection arrangement for introducing extraction liquid into the portion capsule while the receiving element comprises an extraction arrangement in order to remove the extraction liquid interacting with a beverage substance arranged in the portion capsule from the portion capsule and to supply said extraction liquid to a drinking vessel in order to prepare a beverage. In order to fill the brewing device with the portion capsule, the closure element is transferred into a loading position in which said closure element is spaced apart from the receiving element. The portion capsule is subsequently inserted into an intermediate space between the receiving element and the closure element and then the closure element is displaced along an axial direction in the direction of the receiving element, as a result of which the portion capsule is inserted into the cavity in the receiving element. In the extracting position, the receiving element and the closure element form a substantially closed brewing chamber for extracting the portion capsule. The beverage substance comprises in particular roast or instant coffee to be extracted. Furthermore, it is known to provide brewing devices of this type with perforation means which perforate the portion capsule in order to introduce the extraction liquid or to conduct away the beverage extract during or after the closing of the brewing chamber.

There is disadvantageously the risk in such brewing devices of the portion capsule remaining stuck to the perforation means of the first brewing chamber element while being inserted into the intermediate space between the first and the second brewing chamber elements, and therefore the portion capsule cannot be inserted without error. An incorrectly inserted or positioned portion capsule may result in damage to the brewing device.

The invention is therefore based on the object of providing a brewing device for extracting a portion capsule, which brewing device does not have the disadvantages of the prior art and enables a comparatively reliable and error-free insertion of the portion capsule as compared to the prior art.

### SUMMARY

This object is achieved according to the invention by a brewing device for extracting a portion capsule, comprising a first brewing chamber element and a second brewing chamber element, wherein the first brewing chamber element is movable between a loading position, in which the first and the second brewing chamber elements are spaced apart from each other, and an extraction position, in which the first and the second brewing chamber elements are brought closer together in order to form a substantially closed brewing chamber, and wherein the brewing device is designed in such a manner that, during the movement between the loading position and the extraction position, the first brewing chamber element carries out a linear displacement along an axial direction when the first and the second brewing chamber elements are spaced apart from each other, and additionally carries out a pivoting movement about a pivot axis which is perpendicular to the axial direction when the first and the second brewing chamber elements are at least partially brought closer together.

It is thereby possible for the first brewing chamber element to be aligned at an inclination in relation to the second brewing chamber element, at least in the loading position, and, during the movement from the loading position into the extraction position, in particular just before the extraction position is reached, to be brought into an alignment corresponding to the second brewing chamber element. In comparison to the prior art, the risk of the portion capsule remaining stuck to the first brewing chamber element, and in particular to first perforation means of the first brewing chamber element, during insertion into the intermediate space between the first and the second brewing chamber elements, is thus advantageously reduced because of the inclination of the first brewing chamber element in the loading position. Upon hasty use of the brewing device by a user, the closing mechanism for moving the first brewing chamber element from the loading position into the extraction position is frequently actuated although the portion capsule is not yet correctly positioned in the intermediate position. This would result in the portion capsule becoming wedged between a feeding opening for the portion capsule and the first brewing chamber element if the first brewing chamber element were already aligned perpendicularly at the beginning of the movement from the loading position into the extraction position and/or were first of all to be pivoted into the perpendicular. In the case of the brewing device according to the present invention, the risk of wedging is reduced, since, when the closing mechanism is actuated, the first brewing chamber element first of all remains in the inclined position and is only moved axially in the direction of the second brewing chamber element. The first brewing chamber element is aligned only significantly later when the portion capsule is in particular already spaced apart from the feeding opening in the direction of the second brewing chamber element. The first brewing chamber element is preferably pivoted during the pivoting movement by an angle of between 1 and 30 degrees, particularly preferably between 1 and 15 degrees and very particularly preferably by essentially 6 degrees.

During the movement from the loading position into the extraction position, the first brewing chamber element is preferably first of all displaced exclusively linearly along the axial direction in the direction of the second brewing chamber element, and then in addition to the linear displacement along the axial direction in the direction of the second brewing chamber element is also pivoted about the pivot axis (which likewise migrates along the axial direction) and then is displaced exclusively linearly again along the axial direction in the direction of the second brewing chamber element. The end surface of the first brewing chamber element is preferably inclined in the loading direction in relation to the plane perpendicular to the axial direction in such a manner that the distance between the first and the second brewing chamber elements is at the greatest in the vicinity of the feeding opening. The axial direction preferably extends in a horizontal plane, i.e. perpendicularly to the gravitational field.

According to a preferred development, it is provided that an end surface of the first brewing chamber element, which end surface faces the second brewing chamber element, is inclined in the loading position with respect to a plane oriented perpendicularly to the axial direction and is aligned perpendicularly to the axial direction in the extraction position, and therefore a substantially hermetically sealed closing of the brewing chamber by the first brewing chamber element is advantageously ensured and at the same time the portion capsule can be inserted particularly reliably and without being prone to faults transversally with respect to the axial direction. The plane is preferably aligned parallel to the earth's gravitational field and/or parallel to a loading direction along which the portion capsule is inserted into the brewing device.

According to a preferred development, it is provided that the first brewing chamber element is guided between the loading position and the extraction position by means of lateral guide rails, wherein the guide rails substantially extend along the axial direction and, on a region facing the second brewing chamber element, have an offset along the gravitational field, along the loading direction and/or perpendicular to the axial direction. The lateral guide rails preferably comprise an elongated hole in a housing wall of the brewing device, wherein the first brewing chamber element is guided via a transverse bolt arranged in the elongated hole. By means of the offset in the guide rail, the pivoting movement of the first brewing chamber element is automatically caused when the transverse bolt passes the offset. The offset is preferably arranged between two guide rail sections running exclusively along the axial direction.

According to a further subject matter or a preferred development of the present invention, it is provided that the brewing device has a feeding opening which, in the loading position, is provided for feeding the portion capsule along a loading direction between the first and the second brewing chamber elements, wherein the first brewing chamber element has an end surface which faces the second brewing chamber element and, in the loading position, is aligned at an inclination with respect to the loading direction, thus advantageously ensuring the above-described, simple and secure feeding of the portion capsule in a manner not prone to faults. In the extraction position, the end surface is preferably aligned substantially parallel to the loading direction and/or to the gravitational field.

According to a further subject matter or to a preferred development of the present invention, it is provided that the first brewing chamber element has at least one capsule stop for holding the portion capsule, which capsule stop is connected rigidly to the first brewing chamber element and which is substantially arranged below the brewing chamber along the gravitational field. In an advantageous manner, the portion capsule is thereby held by the capsule stop during the filling of the brewing device, during the transportation from the loading position into the extraction position and partially during the transportation back out of the extraction position. The capsule stop is preferably formed integrally with the first brewing chamber element, thus resulting in comparatively cost-effective and simple production. The capsule stop is optionally connected integrally or rigidly to the first brewing chamber element.

According to a further subject matter or to a preferred development of the present invention, it is provided that the brewing device has at least one capsule ejector which is substantially arranged below the brewing chamber along the gravitational field and which, during movement of the first brewing chamber element from the extraction position into the loading position, causes the portion capsule to be removed from a capsule stop which is rigidly connected to the first brewing chamber element. In an advantageous manner, a reliably operating, automatic ejection mechanism is therefore provided, said ejection mechanism ejecting the portion capsule as the first brewing chamber element moves back from the extraction position into the loading position.

According to a preferred development, it is provided that the capsule ejector has an arm which substantially extends along the axial direction and has a free-standing end, wherein the free-standing end in the direction of the second brewing chamber element has a stop surface which is substantially perpendicular to the axial direction and, during the movement of the first brewing chamber element from the extraction position into the loading position, causes the portion capsule to be removed from the capsule stop, and wherein the free-standing end on a side facing away from the second brewing chamber element has a guide slope which, during the movement of the first brewing chamber element from the loading position into the extraction position, permits the portion capsule to remain on the capsule stop. An automatic capsule ejection mechanism is therefore realized in a simple manner, said capsule ejection mechanism permitting reliable transportation of the capsule from the loading position into the extraction position, reliable transportation of the capsule back from the extraction position in the direction of the loading position and, furthermore, reliable ejection of the capsule during the transportation back before the loading position is reached again. The capsule stop is preferably designed in such a manner that at least one free end of the capsule stop can be pivoted elastically away from the brewing chamber, i.e. in particular downward along the gravitional field, and therefore, although the portion capsule can move without great resistance together with the first brewing chamber element from the loading position into the extraction position, said portion capsule, during the movement back from the extraction position into the loading position, strikes against the capsule ejector shortly before reaching the loading position and, in the process, is pushed by the capsule stop such that the portion capsule is ejected under the action of gravitational force out of the region between the first and second brewing chamber elements.

According to a preferred development, it is provided that the brewing device is designed in such a manner that an orientation of the portion capsule in the loading position is substantially identical to an orientation of the portion capsule in the extraction position, wherein a capsule cover of the portion capsule is preferably aligned substantially parallel to the gravitational field and/or to the loading direction. Reorientation of the portion capsule during movement of the first brewing chamber element from the loading position into the extraction position is therefore unnecessary, and therefore malfunctions which may arise, for example, due to the portion capsule slipping or tilting as a consequence of the portion capsule being reoriented in the brewing device are reliably avoided. This reduces the susceptibility of the brewing device to error.

According to a preferred development, it is provided that the first brewing chamber element has first perforation means which protrude perpendicularly from the end surface in the direction of the second brewing chamber element and which are substantially arranged, preferably anti-parallel to the gravitational field, in a region of the end surface that faces away from the capsule stop. The end surface of the first brewing chamber element is preferably inclined in the loading direction in relation to the plane perpendicular to the axial direction in such a manner that the distance between the first and the second brewing chamber elements is at the greatest in the vicinity of the feeding opening, and therefore there is sufficient space in this region in order to arrange the protruding first perforation means without there being a threat of the portion capsule becoming interlocked with the first perforation means during the insertion operation.

According to a preferred development, it is provided that the brewing device is designed in such a manner that the portion capsule is perforated by the first perforation means during the pivoting movement about the pivot axis. The torque of the pivoting first brewing chamber element is used in an advantageous manner in order to produce the perforation. The required effort for a user is therefore reduced and the ease of operation of the brewing device increased.

According to a preferred development, it is provided that the first brewing chamber element comprises a feeding means which, in the extraction position, are provided for feeding extraction liquid into the portion capsule perforated by means of the first perforation means, such that, in the extraction position, the extraction operation for extracting the beverage substance contained in the portion capsule can be carried out.

According to preferred development, it is provided that the first brewing chamber element is coupled to lateral retraining arms which engage behind a capsule flange of the portion capsule and which, together with the first brewing chamber element, are at least partially movable along the axial direction between the loading position and the extraction position. In an advantageous manner, the retaining of the portion capsule position with respect to the horizontal axis is therefore firstly ensured in the loading position and also during the transport from the loading position into the extraction position. Secondly, after the extraction operation, during the movement of the first brewing chamber element back, the portion capsule is at least partially pulled back again out of the second brewing chamber element in order to enable the portion capsule to be ejected. The retaining arms enclose the capsule flange in particular only in the direction of the second brewing chamber element. The retaining arms are optionally connected integrally or rigidly to the first brewing chamber element.

According to a preferred development, it is provided that the retaining arms are movable along the axial direction relative to the first brewing chamber element, and/or in that the retaining arms are coupled to a toggle lever joint which is provided for moving the first brewing chamber element between the loading position and the extraction position. Stable fastening of the retaining arms in a particularly compact manner in terms of construction is thereby obtained. The relative movement between the retaining arms and the first brewing chamber element furthermore permits the capsule flange to be spaced apart from the first brewing chamber element during the movement back of the first brewing chamber element from the extraction position into the loading position. This promotes a friction-free ejection of the portion capsule by the capsule ejector.

According to a preferred development, it is provided that the second brewing chamber element has at least one second perforation means which extends from the second brewing chamber element substantially parallel to the axial direction in the direction of the first brewing chamber element. Drainage of the beverage extract from the portion capsule is therefore ensured in an advantageous manner during the extraction operation.

According to a preferred development, it is provided that the second brewing chamber element comprises a hollow bell-shaped element for receiving the portion capsule in the extraction position, wherein a base region of the bell-shaped element preferably comprises at least one depression for conducting away extraction liquid from the portion capsule perforated by means of the second perforation means, wherein the second perforation means is particularly preferably arranged in the region of the depression, and wherein the depression very particularly preferably leads into a drainage channel for removing the extraction liquid from the brewing chamber. The depression preferably comprises a supporting and/or pillar structure, and therefore the portion capsule is reliably spaced apart in the region of the depression from the second brewing chamber element. This prevents a reduction in the cross section of the depression by means of the capsule base, and therefore the extraction liquid can be reliably conducted away at any time.

According to a preferred development, it is provided that in the extraction position, the capsule stop is substantially arranged below the second brewing chamber element, and/or, in the extraction position, the retaining arms are each arranged laterally next to the second brewing chamber element. In an advantageous manner, the second brewing chamber element has corresponding indentations into which the capsule stop and/or the retaining arms correspondingly move in the extraction position. By comparison to the prior art, lateral pivotability of the retaining arms is therefore not required, and therefore the outlay on producing the brewing device is advantageously reduced.

A further subject matter of the present invention is a method for operating a brewing device, wherein, in a first method step, a portion capsule is inserted between the first and the second brewing chamber elements, and wherein, in a subsequent second method step, the first brewing chamber element is moved from the loading position into the extraction position, wherein, furthermore, during the second method step, the first brewing chamber element is first of all displaced linearly along an axial direction and is subsequently additionally pivoted about a pivot axis perpendicular to the axial direction. As explained above, this obtains a disturbance-free and simple feeding of the portion capsule into the intermediate region between the first and the second brewing capsule elements. In particular, the risk of the portion capsule tilting in the event of the brewing device being put into operation too hastily is reduced. During the movement from the loading position into the extraction position, the first brewing chamber element is preferably first of all displaced exclusively linearly along the axial direction in the direction of the second brewing chamber element, and subsequently, in addition to the linear displacement along the axial direction in the direction of the second brewing chamber element, is also pivoted about the pivot axis (which likewise migrates along the axial direction) and is subsequently displaced again exclusively linearly along the axial direction in the direction of the second brewing chamber element. When the first brewing chamber element moves back from the extraction position into the loading position, said movement steps are run through in precisely the reverse order.

According to a preferred development, it is provided that, in the second movement step, the first brewing chamber element is moved by the pivoting movement from a position in which an end surface of the first brewing chamber element, which end surface faces the second brewing chamber element, is inclined with respect to a plane aligned with respect to the axial direction into a position in which the end surface is aligned perpendicularly to the axial direction. As explained above, reliable insertion of the capsule without being prone to faults is thereby ensured. The first brewing chamber element is preferably pivoted during the pivoting movement by an angle of between 1 and 30 degrees, particularly preferably between 1 and 15 degrees, and very particularly preferably by essentially 6 degrees. The end surface of the first brewing chamber element is preferably inclined in the loading direction with respect to the plane perpendicular to the axial direction in such a manner that the distance between the first and the second brewing chamber elements is at the greatest in the vicinity of the feeding opening.

According to a further subject matter or a preferred development of the present invention, it is provided that, during the second movement step, the first brewing chamber element is moved by the pivoting movement from a position in which an end surface of the first brewing chamber element, which end surface faces the second brewing chamber element, is inclined in relation to a loading direction, along which, in the loading position, the portion capsule is inserted between the first and the second brewing chamber elements, into a position in which the end surface is aligned parallel to the loading direction. As explained above, reliable insertion of the capsule in a manner not prone to error is thereby ensured and at the same time tight closing of the brewing chamber during the extraction operation is obtained.

According to a further subject matter or a preferred development of the present invention, it is provided that the portion capsule which is inserted between the first and the second brewing chamber elements in the loading position is held by means of a capsule stop, wherein the portion capsule is brought out of contact with the capsule stop by means of a capsule ejector while, in a third method step, the first brewing chamber element is moved from the extraction position into the loading position. Automatic ejection of the portion capsule is therefore obtained in an advantageous manner during the movement of the first brewing chamber element back from the extraction position into the loading position.

According to a preferred development, it is provided that the portion capsule is not brought out of contact with the capsule stop while, in the second method step, the first brewing chamber element is moved from the loading position into the extraction position. During the movement of the first brewing chamber element in the direction of the extraction position, inadvertent ejection of a portion capsule which has not yet been extracted is therefore avoided in an advantageous manner.

According to a preferred development, it is provided that, during the second movement step, the orientation of the portion capsule is kept constant, wherein the orientation of a capsule cover of the portion capsule is preferably kept parallel to the gravitational field and/or parallel to the loading direction such that reorientation of the portion capsule within the brewing device is not necessary and, as a result, the susceptibility of the brewing device to error is reduced.

According to a preferred development, it is provided that, in the second method step, the portion capsule is perforated by means of first perforation means of the first brewing chamber element during or temporally after the pivoting movement of the first brewing chamber element. The torque of the pivoting first brewing chamber element is used in an advantageous manner in order to produce the perforation. The required effort for a user is therefore reduced and the ease of operating the brewing device increased.

According to a preferred development, it is provided that, in the second method step, the portion capsule is perforated by means of at least one second perforation means of the second brewing chamber element upon reaching the extraction position, wherein the perforation by means of the second perforation means is carried out temporarily after the perforation by means of the first perforation means. The required effort for perforating the portion capsule is therefore reduced in an advantageous manner.

A further subject matter of the present invention is use of the brewing device according to the invention for preparing hot beverages, in particular coffee, milk and/or chocolate beverages.

The invention is explained in more detail below with reference to exemplary embodiments illustrated in the drawings. The drawings merely illustrate exemplary embodiments of the invention that do not restrict the essential inventive concept.

### BRIEF DESCRIPTION OF THE DRAWINGS

FIGS. 1a to 1k show schematic sectional drawing views of a brewing device according to a first embodiment of the present invention.

FIGS. 2a and 2b show further schematic sectional drawing views of a brewing device according to the first embodiment of the invention.

FIG. 3 shows a frontal view of the first brewing chamber element of a brewing device according to the first embodiment of the invention.

FIGS. 4a and 4b show schematic sectional drawing views of a brewing device according to a second embodiment of the present invention.

FIGS. 5a and 5b show further schematic sectional drawing views of a brewing device according to the second embodiment of the present invention.

In the various figures, identical parts are always provided with the same reference numbers and are therefore generally also referred to or mentioned only once in each case.

### DETAILED DESCRIPTION

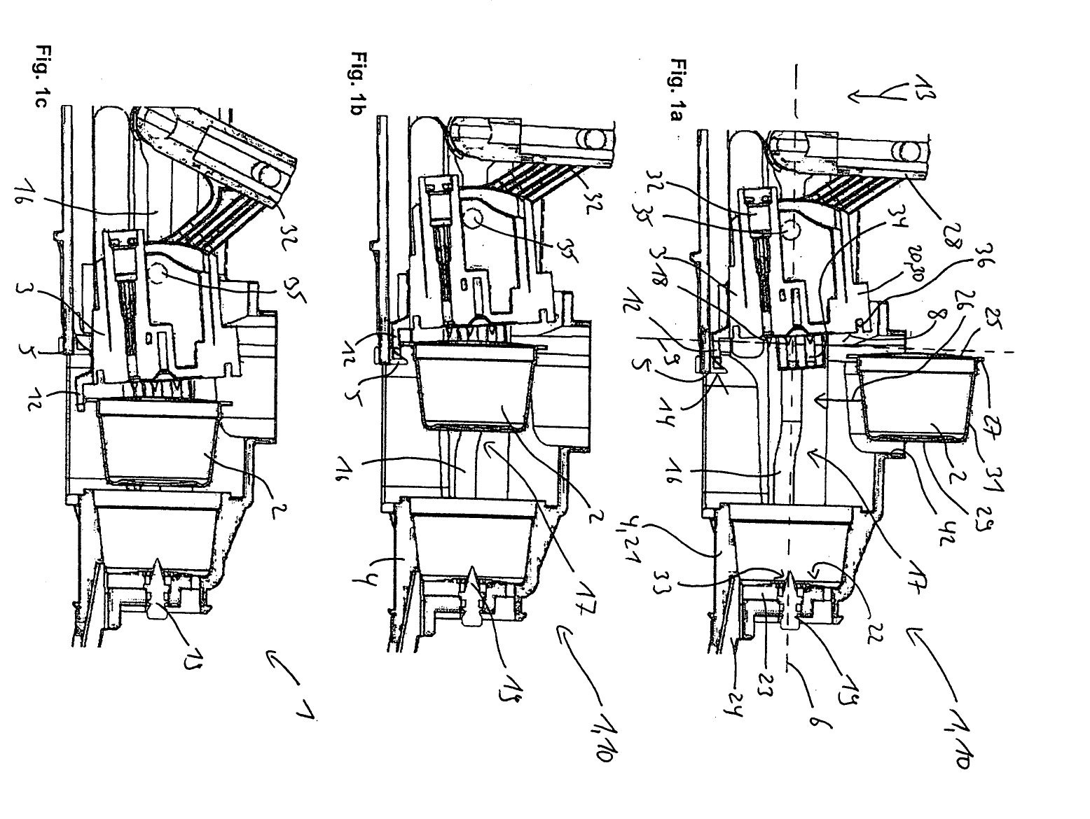

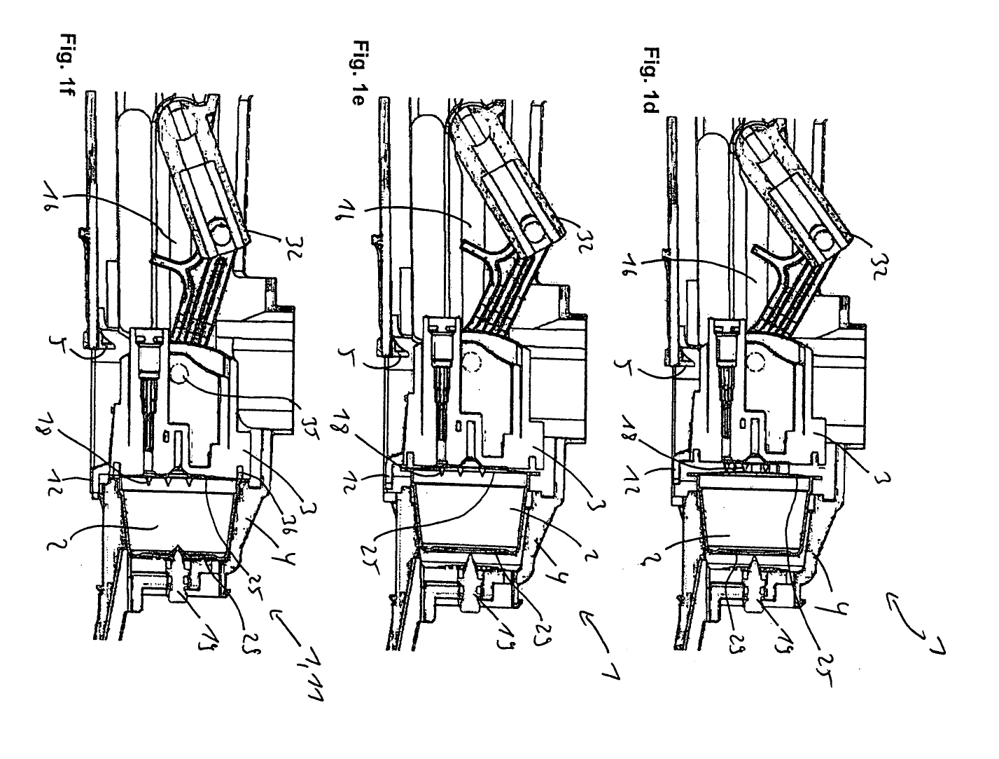

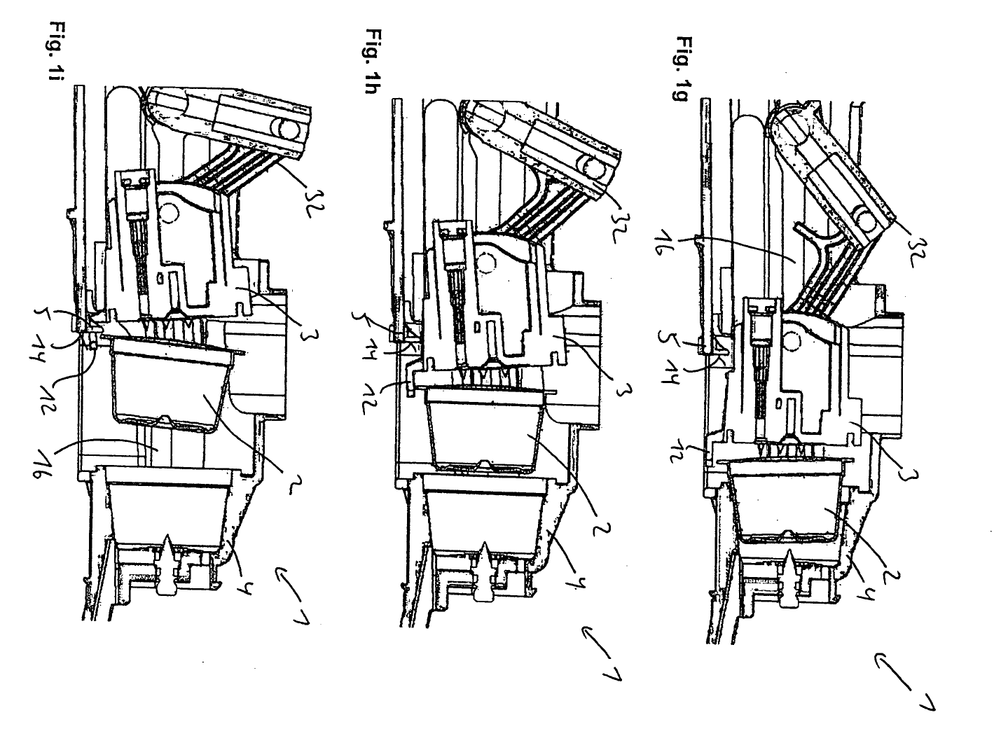

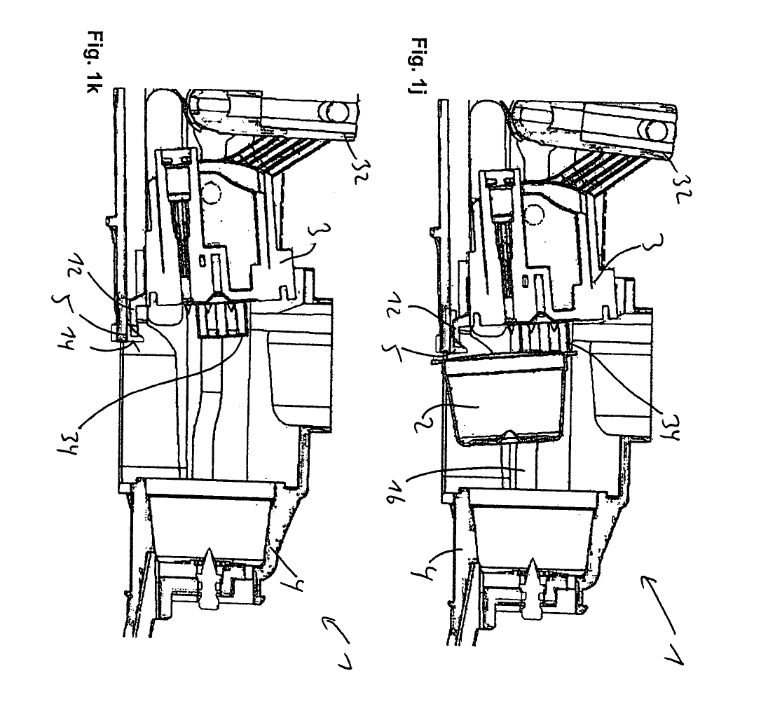

FIGS. 1a to 1k illustrate schematic sectional drawing views of a brewing device 1 for extracting a portion capsule 2 according to a first embodiment of the present invention. The brewing device 1 here comprises a first brewing chamber element 3, which is designed as a receiving element or partially hollow bell-shaped element 21, and a second brewing chamber element 4, which is designed as a closure element 30 or piston. The first brewing chamber element 3 is movable relative to the second brewing chamber element 4 along an axial direction 6 between a loading position 17 illustrated in FIGS. 1a and 1k and an extraction position 11 illustrated in FIG. 1f.

The portion capsule 2 comprises a truncated cone 31 which is manufactured from plastic and is of cup-shaped design. The truncated cone 31 is closed in an airtight manner by means of a capsule cover 25 manufactured from a plastic film or aluminum foil. A beverage substance, in particular a roast coffee powder which can be extracted by means of an extraction liquid is located within the portion capsule 2. The portion capsule 2 optionally has a filtering element (not depicted) which is spaced apart from the capsule base 29 and is arranged between the capsule base 29 and the beverage substance. The capsule cover 25 is adhesively bonded or welded to the truncated cone 31 in the region of a capsule flange 27.

The first brewing chamber element 3 has a plurality of first perforation means 18 on an end surface 8 facing the second brewing chamber element 4. The first perforation means 18 respectively comprise perforation points which protrude from the end surface 8 in the direction of the second brewing chamber element 4. Furthermore, water outlet openings (which cannot be seen for perspective reasons in FIGS. 1a to 1k) are formed in the end surface 8, wherein precisely one water outlet opening is always arranged in the vicinity of a perforation point. The first brewing chamber element 3 furthermore has a water feeding channel 32 which is provided for supplying extraction liquid to the water outlet openings. The lower side of the first brewing chamber element 3 furthermore has a capsule stop 12 which is connected rigidly and in particular integrally to the first brewing chamber element 3 and, in the extraction position 11, is arranged below the brewing chamber 1′ and below the second brewing chamber element 4. Furthermore, the first brewing chamber element 3 has two lateral retaining arms 34, the free ends of which face one another and laterally surround the capsule flange 27. The second brewing chamber element 4 has a second perforation means 19 which comprises a piercing point which points in the direction of the first brewing chamber element 3, is arranged within the cavity and is connected releasibly to the second brewing chamber element 4 preferably via a latching closure. The piercing point is provided with lateral grooves 33 which extend parallel to the axial direction 6. In the region of the piercing point, the second brewing chamber element 4 has a depression 23 in the base region 22 of the cavity, into which depression a drainage channel 24 opens.

FIG. 1a illustrates the first brewing chamber element 3 in the loading position 10, i.e. the first brewing chamber element 3 is spaced apart from the second brewing chamber element 4 along the axial direction 6. In said starting position, the portion capsule 2 is then inserted by a user (not depicted) along a loading direction 26 into an intermediate region between the first and the second brewing chamber elements 3, 4. For this purpose, a housing of the brewing device 1, which housing is designed as part of the second brewing chamber element 4, has a feeding opening 42 through which the portion capsule 2 is inserted. In the process, the first brewing chamber element 3 is tilted in relation to the second brewing chamber element 4 in such a manner that the end surface 8 is inclined both in relation to the loading direction 26 and in relation to a plane 9 perpendicular to the axial direction 6, in particular by an angle of between 2 and 10 degrees. By means of this inclination, that region of the first brewing chamber element 3 which faces the feeding opening 42 is furthest away from the second brewing chamber element 4, and therefore the portion capsule 2 is insertable into the intermediate region without the portion capsule 2 threatening to become interlocked in the process with the first perforation means 18.

It is illustrated in FIG. 1b that the portion capsule 2 drops laterally under the action of gravitational force into the region between the first and the second brewing chamber elements 3, 4 where it rests on the capsule stop 12. At the same time, a tilting of the portion capsule 2 in the direction of the second brewing chamber element 4 is prevented by the lateral retaining arms 35 by the capsule flange 27 being supported on the retaining arms 35 in the direction of the second brewing chamber element 4 such that the portion capsule 2 is aligned substantially axially along the axial direction 6. Consequently, the capsule cover 25 and the capsule base 29 are aligned substantially parallel to the plane 9 and to the loading direction 26. By means of the inclination of the first brewing chamber element 3, contact between the first perforation means 18 and the capsule cover 25 is largely avoided. The free outer end of the capsule stop 12 optionally has an edge which prevents inadvertent slipping of the capsule flange 27 from the capsule stop 12. Furthermore, the capsule stop 12 is preferably slightly inclined in the direction of the loading direction 26. The capsule ejector 5 has a free end which runs along the plane 9 at least partially at the same height as the capsule stop 12 and therefore also as the capsule flange 27. On a side facing away from the second brewing chamber element 4, the free end has a guide slope 15 inclined in relation to the plane 9, and therefore the capsule flange 27 can be pushed in a simple manner from the first brewing chamber element 3 via the capsule ejector 5 in the direction of the second brewing chamber element 4 without the capsule flange 27 slipping in the process from the capsule stop 12.

In the next step, illustrated with reference to FIG. 1c, the first brewing chamber element 3 is driven via a toggle lever joint 28 to perform a linear displacement along the axial direction 6 in the direction of the second brewing chamber element 4. In this case, the orientation of the portion capsule 2 remains constant with respect to the loading position 10 shown in FIGS. 1a and 1b. The first brewing chamber element 3 is guided by means of a transverse bolt 35 in a lateral guide rail 16 designed as an elongated hole, wherein the first brewing chamber element 3 first of all runs in FIG. 1c along a section of the guide rail 16 that runs exclusively axially. By means of continuous movement of the first brewing chamber element 3 in the direction of the second brewing chamber element 4, the portion capsule 2 is subsequently successively inserted into the cavity of the bell-shaped element 21.

It is illustrated with reference to FIG. 1d that, shortly before or while the capsule base 29 touches the second perforation means 19, the transverse bolt 35 passes an offset 17 in the guide rails 16, as a result of which the first brewing chamber element 3 carries out a pivoting movement about a pivot axis 7 (in particular migrating along the axial direction 6). The first brewing chamber element 3 is pivoted unit the end surface 8 is aligned parallel to the plane 7 and therefore perpendicular to the axial direction 6. The first and the second brewing chamber elements 3, 4 are therefore aligned substantially parallel to each other. The first perforation means 18 then enter into contact with the capsule cover 25.

In the next step, illustrated in FIG. 1e, the capsule cover 25 is perforated by the first perforation means 18, which are designed as perforation points, by the continuous movement of the first brewing chamber element 3 in the direction of the second brewing chamber element 4. The transverse bolt 35 is now guided on a further section of the guide rail 16, which section runs exclusively parallel to the axial direction 6. Accordingly, the offset 17 is arranged between two sections of the guide rail 16, which sections run exclusively along the axial direction 6. The offset 17 can only be seen in FIGS. 1a, 1b and 1k, since the offset is concealed in the other figures by the first brewing chamber element 3. The capsule base 29 is not yet perforated at the time illustrated in FIG. 1d.

In FIG. 1f, the first brewing chamber element 3 is displaced as far as the second brewing chamber element 4 along the axial direction 6 into the extraction position 11 such that the portion capsule 2 is virtually completely inserted into the cavity of the hollow bell-shaped element 21 and the capsule base 29 is then perforated by the second perforation means 19, which is designed as a piercing spike. The first and the second brewing chamber elements 3, 4 therefore form a hermetically closed brewing chamber 1′, in which the portion capsule 2 is arranged. In this case, the capsule flange 27 is fixedly clamped between the first and the second brewing chamber elements 3, 4, in particular by means of an elastic sealing ring 36. The capsule stop 12 is arranged here below the second brewing chamber element 4.

In this position, the extraction operation is initiated, i.e. extraction liquid in the form of pressurized and heated water is fed to the brewing chamber 1′. The extraction liquid is conveyed through the water feeding channel 32 to the water outlet opening and passes from there through the perforation openings, which are produced by means of the first perforation means 18, in the capsule cover 25 into the portion capsule 2. The extraction liquid flows through the beverage substance thus forming a beverage extract which leaves the portion capsule 2 again through the perforation hole produced in the capsule base 29 by means of the piercing spike and passes through the depression 23 into the drainage channel 24. By means of the drainage channel 24, the beverage extract is preferably fed directly to a drinking vessel (not depicted), such as, for example, a coffee cup.

After the extraction operation, the first brewing chamber element 3 is moved back again from the extraction position 11 in the direction of the loading position 10. In the process, the extracted portion capsule 2 is pulled again out of the cavity of the bell-shaped element 21 by means of the retaining arms and transported in the direction of the loading position 10. This is illustrated with reference to FIGS. 1g and 1h, wherein, during said movement back, the transverse bolt 35 again passes the offset 17 in the guide rail 16, as a result of which the first brewing chamber element 3 is brought again into an inclined position in relation to the plane 17 and the loading direction 26.

By means of the continuous movement back of the first brewing chamber element 3, the capsule flange 27, as illustrated in FIG. 1i, strikes against a stop surface 14 of the capsule ejector 5, which stop surface faces the second brewing chamber element 4.

It is illustrated with reference to FIG. 1j that, by means of the capsule flange 27 striking against the stop surface 14, the portion capsule 2 is pushed from the capsule stop 12 during the movement back of the first brewing chamber element 3. The used portion capsule 2 subsequently drops automatically under the action of gravitational force out of the region between the first and the second brewing chamber elements 3, 4, for example into a collecting container (not shown).

Subsequently, the first brewing chamber element 3 is again located, as shown in FIG. 1k, in the loading position 10, and therefore renewed filling of the brewing device 1 with an unused portion capsule 2 is possible as per FIG. 1a.

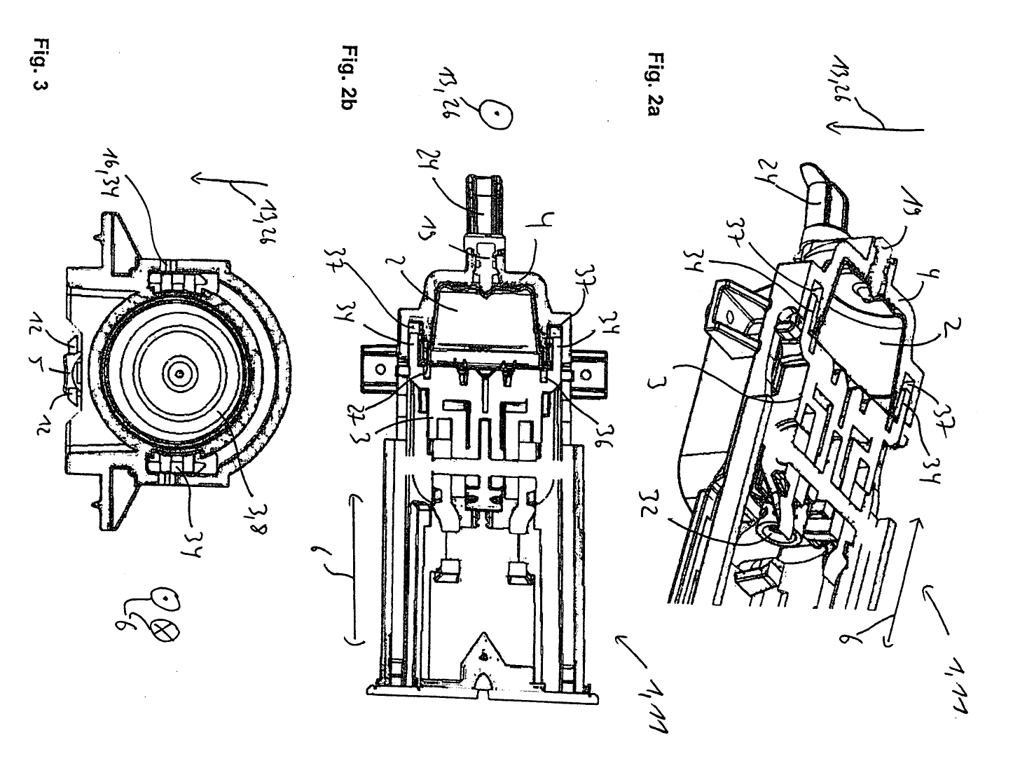

FIGS. 2a and 2b show further schematic sectional drawing views of a brewing device 1 according to the first embodiment of the invention. FIG. 2a illustrates the brewing device 1 in a perspective sectional drawing view along a sectional plane perpendicular to the loading direction 26 while said sectional drawing view is illustrated in FIG. 2b in a top view along the loading direction 26. The first brewing chamber element 3 is in each case in the extraction position 11 here. It can be seen that the lateral retaining arms 35 are moved into lateral indentations 37 of the second brewing chamber element 4 in the extraction position.

FIG. 3 illustrates a frontal view of the first brewing chamber element 3 of a brewing device 1 according to the first embodiment of the invention, wherein the first brewing chamber element 3 is illustrated along the axial direction 6 from the view of the second brewing chamber element 4 and wherein, for reasons of clarity, no first perforation means 18 and no water outlet openings are illustrated.

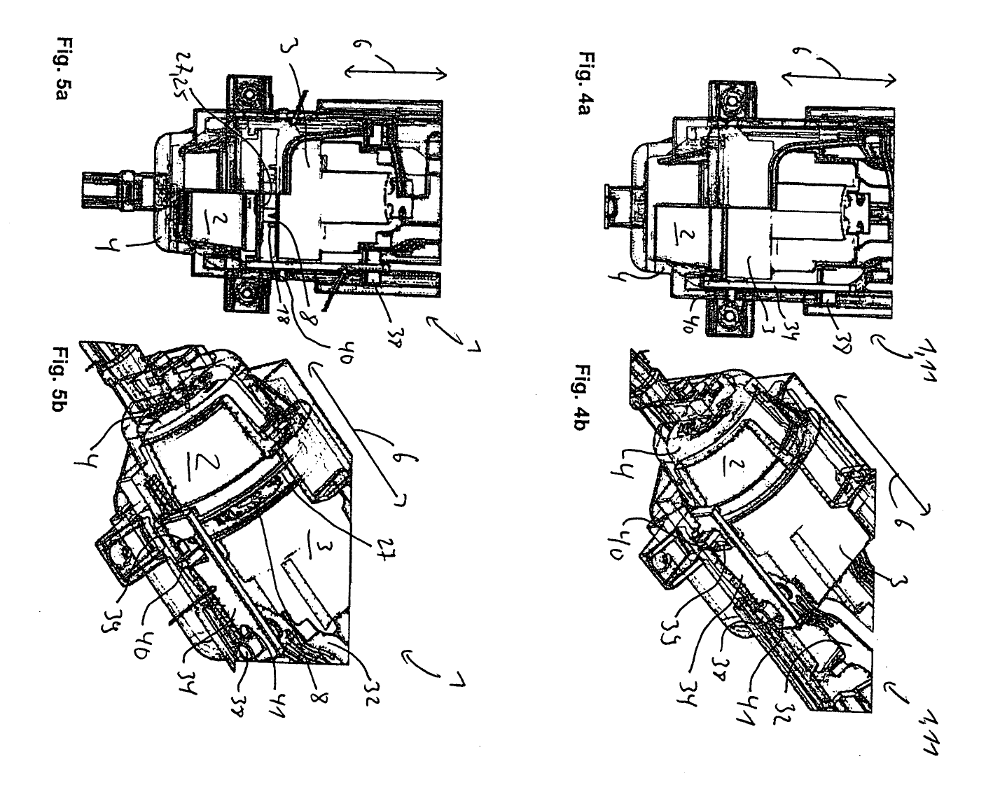

FIGS. 4a and 4b illustrate schematic sectional drawing views of a brewing device 1 according to a second embodiment of the present invention, wherein the second embodiment is substantially equivalent to the first embodiment illustrated in FIGS. 1a to 3. The first brewing chamber element 3 is illustrated in the extraction position 11 in FIGS. 4a and 4b. By contrast to the first embodiment, in the second embodiment, the retaining arms 34 are not connected integrally and rigidly to the first brewing chamber element 3 but instead are in each case coupled moveably via a first elongated hole 39 to a first bolt 40 of the first brewing chamber element 3 and coupled moveably via a second elongated hole 41 to a rotary spindle 38 of the toggle lever joint 28. Each retaining arm 34 is therefore mounted displaceably along the axial direction 6 relative to the first brewing chamber element 3.

FIGS. 5a and 5b illustrate further schematic sectional drawing views of a brewing device 1 according to the second embodiment of the present invention, wherein the first brewing chamber element 3 is arranged in the extraction position 11, as in FIGS. 4a and 4b, but is already moved slightly back from the extraction position 11 in the direction of the loading position 10. The retaining arms 34 are therefore displaced in relation to the first brewing chamber element 3 such that the capsule cover 25 is slightly spaced apart from the end surface 8.

Possible embodiments of the brewing device according to the invention are described below.

Embodiment 1 relates to a brewing device 1 for extracting a portion capsule 2, comprising a first brewing chamber element 3 and a second brewing chamber element 4, wherein the first brewing chamber element 3 is movable between a loading position 10, in which the first and the second brewing chamber elements 3, 4 are spaced apart from each other, and an extraction position, in which the first and the second brewing chamber elements 3, 4 are brought closer together in order to form a substantially closed brewing chamber 1′, characterized in that the brewing device 1 is designed in such a manner that, during the movement between the loading position 10 and the extraction position 11, the first brewing chamber element 3 carries out a linear displacement along an axial direction 6 when the first and the second brewing chamber elements 3, 4 are spaced apart from each other, and additionally carries out a pivoting movement about a pivot axis 7 which is perpendicular to the axial direction 6 when the first and the second brewing chamber elements 3, 4 are at least partially brought closer together.

Embodiment 2 relates to brewing device 1 according to embodiment 1, characterized in that, in the loading position 10, a end surface 8 of the first surface brewing chamber element 3, which end surface faces the second brewing chamber element 4, is inclined in relation to a plane 9 aligned perpendicularly to the axial direction 6 and, in the extraction position 11, is aligned perpendicularly to the axial direction 6.

Embodiment 3 relates to a brewing device 1 according to one of the preceding embodiments, characterized in that the first brewing chamber element 3 is guided between the loading position 10 and the extraction position 11 by means of lateral guide rails 16, wherein the guide rails 16 extend substantially along the axial direction 6 and, on a region facing the second brewing chamber element 4, have an offset 17 perpendicular to the axial direction 6.

Embodiment 4 relates to a brewing device 1 according to the one of the preceding embodiments or according to the preamble of embodiment 1, characterized in that the brewing device 1 has a feeding opening 42 which, in the loading position 10, is provided for feeding the portion capsule 2 between the first and the second brewing chamber elements 3, 4 along a loading direction 26, wherein the first brewing chamber element 3 has an end surface 8 which faces the second brewing chamber element 4 and, in the loading position 10, is aligned at an inclination with respect to the loading direction 26.

Embodiment 5 relates to a brewing device 1 according to embodiment 4, characterized in that, in the extraction position 11, the end surface 8 is aligned substantially parallel to the loading direction 26.

Embodiment 6 relates to a brewing device 1 according to one of the preceding embodiments or according to the preamble of embodiment 1, characterized in that the first brewing chamber element 3 has at least one capsule stop 12 for holding the portion capsule 2, which capsule stop is connected rigidly to the first brewing chamber element 3 and which is substantially arranged below the brewing chamber 1′ along the gravitational field 13.

Embodiment 7 relates to a brewing device 1 according to one of the preceding embodiments or according to the preamble of embodiment 1, characterized in that the brewing device 1 has at least one capsule ejector 5 which is substantially arranged below the brewing chamber 1′ along the gravitational field 13 and which, during movement of the first brewing chamber element 3 from the extraction position 11 into the loading position 10, causes the portion capsule 2 to be removed from a capsule stop 12 which is rigidly connected to the first brewing chamber element 3.

Embodiment 8 relates to a brewing device 1 according to embodiment 7, characterized in that the capsule ejector has an arm which substantially extends along the axial direction 6 and has a free-standing end, wherein the free-standing end in the direction of the second brewing chamber element 4 has a stop surface 14 which is substantially perpendicular to the axial direction 6 and, during the movement of the first brewing chamber element 3 from the extraction position 11 into the loading position 10, causes the portion capsule 2 to be removed from the capsule stop 12, and wherein the free-standing end on a side facing away from the second brewing chamber element 4 has a guide slope 15 which, during the movement of the first brewing chamber element 3 from the loading position 10 into the extraction position 11, permits the portion capsule 2 to remain on the capsule stop 12.

Embodiment 9 relates to a brewing device 1 according to one of the preceding embodiments, characterized in that the brewing device 1 is designed in such a manner that an orientation of the portion capsule 2 in the loading position 10 is substantially identical to an orientation of the portion capsule 2 in the extraction position 11, wherein a capsule cover 25 of the portion capsule 2 is preferably aligned parallel to the gravitational field 13 and/or to the loading direction 26.

Embodiment 10 relates to a brewing device 1 according to one of the preceding embodiments, characterized in that the first brewing chamber element 3 has first perforation means 18 which protrude perpendicularly from the end surface 8 in the direction of the second brewing chamber element 4 and which are substantially arranged, preferably anti-parallel to the gravitational field 13, in a region of the end surface 8 that faces away from the capsule stop 12.

Embodiment 11 relates to a brewing device according to embodiment 10, characterized in that the brewing device 1 is designed in such a manner that the portion capsule 2 is perforated by the first perforation means 18 during the pivoting movement about the pivot axis 7.

Embodiment 12 relates to a brewing device according to one of the embodiments 9 or 10, characterized in that the first brewing chamber element 3 comprises a feeding means 20 which, in the extraction position 11, is provided for feeding extraction liquid into the portion capsule 2 perforated by means of the first perforation means 18.

Embodiment 13 relates to a brewing device according to one of the preceding embodiments, characterized in that the first brewing chamber element 3 is coupled to lateral retaining arms 34 which engage behind a capsule flange 27 of the portion capsule 2 and which, together with the first brewing chamber element 3, are at least partially movable along the axial direction 6 between the loading position 10 and the extraction position 11.

Embodiment 14 relates to a brewing device according to embodiment 13, characterized in that the retaining arms 34 are rigid or are movable along the axial direction 6 relative to the first brewing chamber element 3, and/or in that the retaining arms 34 are coupled to a toggle lever joint 28 which is provided for moving the first brewing chamber element 3 between the loading position 10 and the extraction position 11.

Embodiment 15 relates to a brewing device 1 according to one of the preceding embodiments, characterized in that the second brewing chamber element 4 has at least one second perforation means 19 which extends from the second brewing chamber element 4 substantially parallel to the axial direction 6 in the direction of the first brewing chamber element 3.

Embodiment 16 relates to a brewing device 1 according to embodiment 15, characterized in that the second brewing chamber element 4 comprises a hollow bell-shaped element 21 for receiving the portion capsule 2 in the extraction position 11, wherein a base region 22 of the bell-shaped element 21 preferably comprises at least one depression 23 for conducting away extraction liquid from the portion capsule 2 perforated by means of the second perforation means 19, wherein the second perforation means 19 is particularly preferably arranged in the region of the depression 23, and wherein the depression 23 very particularly preferably leads into a drainage channel 24 for removing the extraction liquid from the brewing chamber 1′.

Embodiment 17 relates to a brewing device 1 according to one of the preceding embodiments, characterized in that, in the extraction position 11, the capsule stop 12 is substantially arranged below the second brewing chamber element 4, and/or, in the extraction position 11, the retaining arms 34 are each arranged laterally next to the second brewing chamber element 4.

Embodiment 18 relates to a method for operating a brewing device 1, in particular according to one the preceding embodiments, or according to the preamble of embodiment 1, wherein, in a first method step, a portion capsule 2 is inserted between the first and the second brewing chamber elements 3, 4, and wherein, in a subsequent second method step, the first brewing chamber element 3 is moved from the loading position 17 into the extraction position 11, characterized in that, during the second method step, the first brewing chamber element 3 is first of all displaced linearly along an axial direction 6 and is subsequently additionally pivoted about a pivot axis 7 perpendicular to the axial direction 6.

Embodiment 19 relates to a method according to embodiment 18, characterized in that, in the second method step, the first brewing chamber element 3 is moved by the pivoting movement from a position in which an end surface 8 of the first brewing chamber element 3, which end surface faces the second brewing chamber element 4, is inclined with respect to a plane 9 aligned with the axial direction 6, into a position in which the end surface 8 is aligned perpendicularly to the axial direction 6.

Embodiment 20 relates to a method according to either of embodiments 18 and 19 or according to the preamble of embodiment 19, characterized in that, during the second method step, the first brewing chamber element 3 is moved by the pivoting movement from a position in which an end surface 8 of the first brewing chamber element 3, which end surface faces the second brewing chamber element 4, is inclined with respect to a loading direction 26 along which, in the loading position 10, the portion capsule 2 is inserted between the first and the second brewing chamber elements 3, 4, into a position in which the end surface 8 is aligned parallel to the loading direction 26.

Embodiment 21 relates to a method according to one of embodiments 18 to 20 or according to the preamble of embodiment 18, characterized in that the portion capsule 2 which is inserted between the first and the second brewing chamber elements 3, 4 in the loading position 10 is held by means of a capsule stop 12, wherein the portion capsule 2 is brought out of contact with the capsule stop 12 by means of a capsule ejector 5 while, in a third method step, the first brewing chamber element 3 is moved from the extraction position 11 into the loading position 10.

Embodiment 22 relates to a method according to embodiment 21, characterized in that the portion capsule 2 is not brought out of contact with the capsule stop 12 while, in the second method step, the first brewing chamber element 3 is moved from the loading position 10 into the extraction position 11.

Embodiment 23 relates to a method according to one of embodiments 18 to 22, characterized in that, during the second method step, the orientation of the portion capsule 2 is kept constant, wherein the orientation of a capsule cover 25 of the portion capsule 2 is preferably kept parallel to the gravitational field 13 and/or parallel to the loading direction 26.

Embodiment 24 relates to a method according to one of embodiments 18 to 23, characterized in that, in the second method step, the portion capsule 2 is perforated by means of first perforation means 18 of the first brewing chamber element 3 during or temporally after the pivoting movement of the first brewing chamber element 3.

Embodiment 25 relates to a method according to embodiment 24, characterized in that, in the second method step, the portion capsule 2 is perforated by means of at least one second perforation means 19 of the second brewing chamber element 4 upon reaching the extraction position, wherein the perforation by means of the second perforation means 19 is carried out temporally after the perforation by means of the first perforation means 18.

Use of an embodiment of a brewing device 1 according to one of embodiments 1 to 17 for preparing hot beverages, in particular coffee, milk and/or chocolate beverages.

1. A brewing device for extracting a portion capsule, comprising a first brewing chamber element and a second brewing chamber element, wherein the first brewing chamber element is movable between a loading position, in which the first and the second brewing chamber elements are spaced apart from each other, and an extraction position, in which the first and the second brewing chamber elements are brought closer together in order to form a substantially closed brewing chamber, characterized in that the brewing device is designed in such a manner that, during the movement between the loading position and the extraction position, the first brewing chamber element carries out a linear displacement along an axial direction when the first and the second brewing chamber elements are spaced apart from each other, and additionally carries out a pivoting movement about a pivot axis which is perpendicular to the axial direction when the first and the second brewing chamber elements are at least partially brought closer together, wherein the first brewing chamber element is guided between the loading position and the extraction position by means of lateral guide rails, wherein the guide rails extend substantially along the axial direction and, on a region facing the second brewing chamber element, have an offset perpendicular to the axial direction.

2. The brewing device as claimed in claim 1, characterized in that the first brewing chamber element has at least one capsule stop for holding the portion capsule, which capsule stop is connected rigidly to the first brewing chamber element and which is substantially arranged below the brewing chamber along the gravitational field.

3. The brewing device as claimed in claim 1, characterized in that the brewing device has at least one capsule ejector which is substantially arranged below the brewing chamber along the gravitational field and which, during movement of the first brewing chamber element from the extraction position into the loading position, causes the portion capsule to be removed from a capsule stop which is rigidly connected to the first brewing chamber element.

4. The brewing device as claimed in claim 3, characterized in that the capsule ejector has an arm which substantially extends along the axial direction and has a free-standing end, wherein the free-standing end in the direction of the second brewing chamber element has a stop surface which is substantially perpendicular to the axial direction and, during the movement of the first brewing chamber element from the extraction position into the loading position, causes the portion capsule to be removed from the capsule stop, and wherein the free-standing end on a side facing away from the second brewing chamber element has a guide slope which, during the movement of the first brewing chamber element from the loading position into the extraction position, permits the portion capsule to remain on the capsule stop.

5. The brewing device as claimed in claim 1, characterized in that the first brewing chamber element has first perforation means which protrude perpendicularly from the end surface in the direction of the second brewing chamber element and which are substantially arranged, anti-parallel to the gravitational field, in a region of the end surface that faces away from the capsule stop.

6. The brewing device as claimed in claim 5, characterized in that the brewing device is designed in such a manner that the portion capsule is perforated by the first perforation means during the pivoting movement about the pivot axis.

7. The brewing device as claimed in claim 5, characterized in that the first brewing chamber element comprises a feeding means which, in the extraction position, is provided for feeding extraction liquid into the portion capsule perforated by means of the first perforation means.

8. The brewing device as claimed in claim 1, characterized in that the first brewing chamber element is coupled to lateral retaining arms which engage behind a capsule flange of the portion capsule and which, together with the first brewing chamber element, are at least partially movable along the axial direction between the loading position and the extraction position.

9. The brewing device as claimed in claim 8, characterized in that the retaining arms are rigid or are movable along the axial direction relative to the first brewing chamber element, and/or in that the retaining arms are coupled to a toggle lever joint which is provided for moving the first brewing chamber element between the loading position and the extraction position.

10. The brewing device as claimed in claim 1, characterized in that the second brewing chamber element has at least one second perforation means which extends from the second brewing chamber element substantially parallel to the axial direction in the direction of the first brewing chamber element.

11. The brewing device as claimed in claim 10, characterized in that the second brewing chamber element comprises a hollow bell-shaped element for receiving the portion capsule in the extraction position, wherein a base region of the bell-shaped element comprises at least one depression for conducting away extraction liquid from the portion capsule perforated by means of the second perforation means, wherein the second perforation means is arranged in the region of the depression, and wherein the depression leads into a drainage channel for removing the extraction liquid from the brewing chamber.

12. The brewing device as claimed in claim 1, characterized in that, in the extraction position, the capsule stop is substantially arranged below the second brewing chamber element, and/or, in the extraction position, the retaining arms are each arranged laterally next to the second brewing chamber element.

13. A method for operating a brewing device comprising a first brewing chamber element guided between a loading position and an extraction position by means of lateral guide rails, wherein the guide rails extend substantially along the axial direction and, on a region facing a second brewing chamber element, have an offset perpendicular to the axial direction, the method comprising, in a first method step, a portion capsule is inserted between the first and the second brewing chamber elements, and, in a subsequent second method step, the first brewing chamber element is moved from the loading position into the extraction position, characterized in that, during the second method step, the first brewing chamber element is first of all displaced linearly along an axial direction and is subsequently additionally pivoted about a pivot axis perpendicular to the axial direction.

14. The method as claimed in claim 13, characterized in that the first brewing chamber element has at least one capsule stop for holding the portion capsule, which capsule stop is connected rigidly to the first brewing chamber element and which is substantially arranged below the brewing chamber along the gravitational field, wherein the portion capsule which is inserted between the first and the second brewing chamber elements in the loading position is held by means of a capsule stop, wherein the portion capsule is brought out of contact with the capsule stop by means of a capsule ejector while, in a third method step, the first brewing chamber element is moved from the extraction position into the loading position.

15. The method as claimed in claim 13, characterized in that, in the second method step, the portion capsule is perforated by means of first perforation means of the first brewing chamber element during or temporally after the pivoting movement of the first brewing chamber element, wherein, in the second method step, the portion capsule is perforated by means of at least one second perforation means of the second brewing chamber element upon reaching the extraction position, wherein the perforation by means of the second perforation means is carried out temporally after the perforation by means of the first perforation means.
